(19) United States
(12) Patent Application Publication
(10) Pub. No.: US 2006/0275530 A1
(43) Pub. Date: Dec. 7, 2006

(54) Package for pasta, machine and method for obtaining said package

(75) Inventor: Cosimo Rommo, Benevento (IT)

Correspondence Address: YOUNG & THOMPSON, 745 SOUTH 23RD STREET, 2ND FLOOR, ARLINGTON, VA, 22202, US

(73) Assignee: Rummo S.P.A., Benevento (IT)

(21) Appl. No.: 10/551,379

(22) PCT Filed: Mar. 29, 2004
(86) PCT No.: PCT/IT04/00159

§ 371 Date: Sep. 29, 2005

(30) Foreign Application Priority Data
Mar. 31, 2003 (IT) RM2003A000145

(51) Int. Cl. B65D 75/58; A21D 10/02

(52) U.S. Cl. 426/122

(57) ABSTRACT

A food package for pasta includes a soft bag (2) which contains a determined quantity of pasta (3) and has a weakened area (5) for the opening of the bag (2); the weakened area (5) has at least a pre-cut line (6) associated to elements (7) for breaking the bag (2) at the pre-cut line (6). The elements (7) for breaking the bag (2) include a tear-out bag (8) associated to the pre-cut line (6).

### TECHNICAL FIELD

The present invention relates to a food package for pasta and a machine and a method for obtaining said package.

In particular, the present invention relates to soft packages obtained with a plastic film, for instance made of polypropylene.

### BACKGROUND ART

It is well known that packages are formed starting from a continuous polypropylene strip which is cut and wound on itself to constitute a tubular bag. The opposite longitudinal edges of the case are sealed to each other and one of the two ends of the tube is also closed by sealing.

Subsequently, after filling the package with a predetermined quantity of pasta, the second end is also closed by sealing.

The main drawback of known soft packages, summarily described above, is linked to the final user's difficulty in opening the package without excessively tearing the bag. Oftentimes, an excessive traction exerted on the edges of the seals causes the undesired breakage of a sizeable portion of the package which, consequently, is no longer suitable to contain any unused pasta

### DISCLOSURE OF INVENTION

In this situation, the technical task constituting the basis of the present invention is to propose a food package for pasta which can be opened easily, without the risk of excessively tearing it.

In particular, an object of the present invention is to provide a food package for pasta in accordance with one or more of the claims from 1 through 13.

Another object of the present invention is also to provide a machine and a method for obtaining said package.

In particular, an object of the present invention is to provide a method for obtaining a food package for pasta as claimed in one or more of the claims from 14 through 20.

Lastly, a further object of the present invention is to propose a machine for obtaining a food package for pasta as claimed in one or more of the claims from 21 through 30.

The technical task and the specified objects are achieved by a machine, by a method and by a package having the characteristics set out in one or more of the appended claims.

Purely by way of non limiting indicative example, the description shall now be provided of a preferred, but not exclusive, embodiment of a food package for pasta, of a machine and of a method for obtaining it, according to the invention, illustrated in the accompanying drawings, in which:

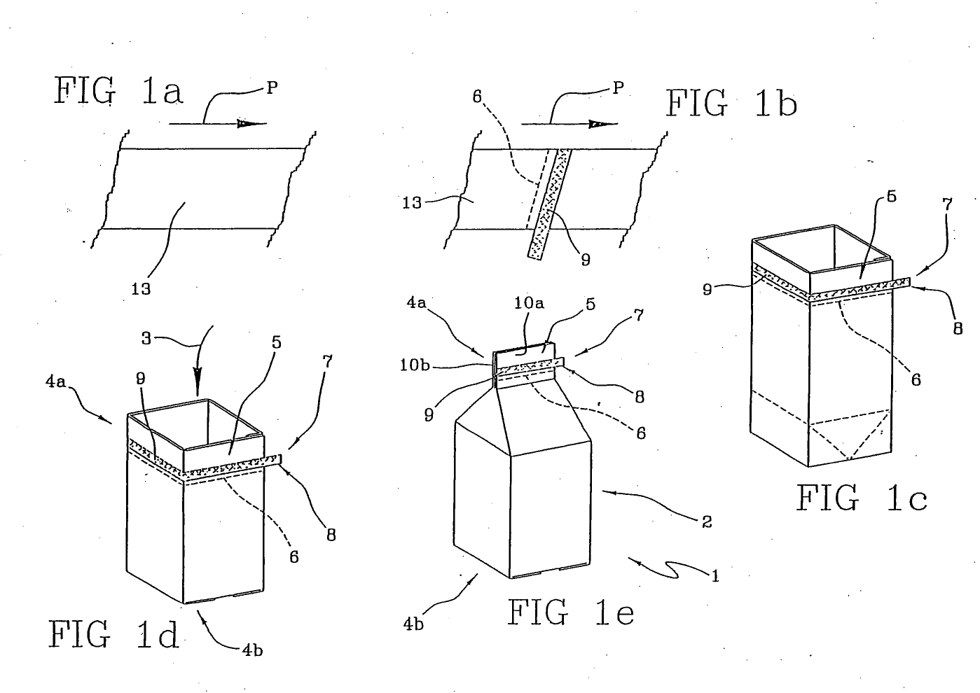

FIGS. 1a-1f show a succession of steps for obtaining a food package for pasta in accordance with a first embodiment of the present invention;

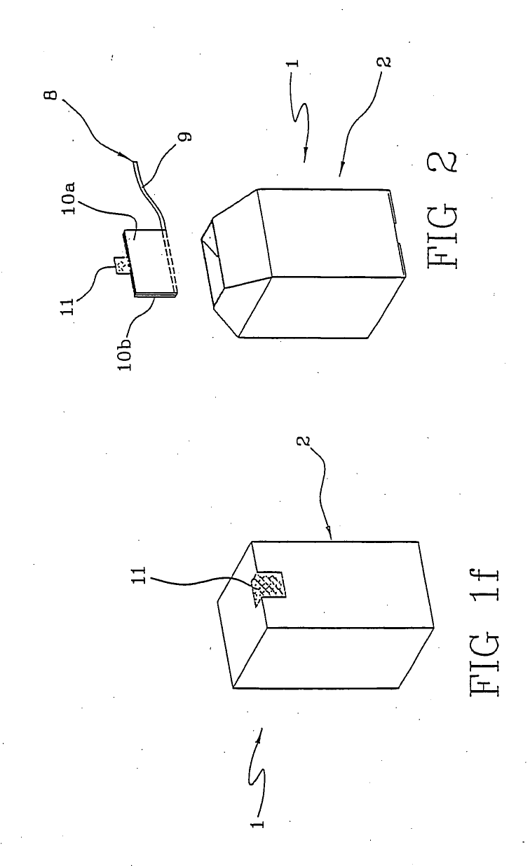

FIG. 2 shows the package of FIGS. 1a-1f, in an opening step;

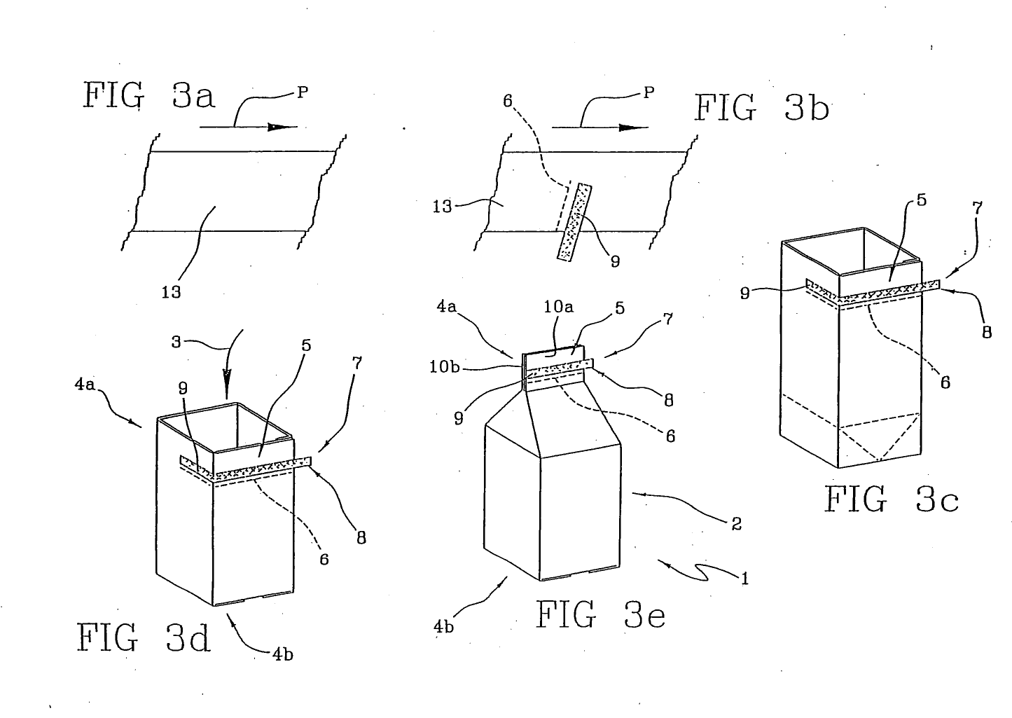

FIGS. 3a-3f show a succession of steps for obtaining a food package for pasta in accordance with a second embodiment of the present invention;

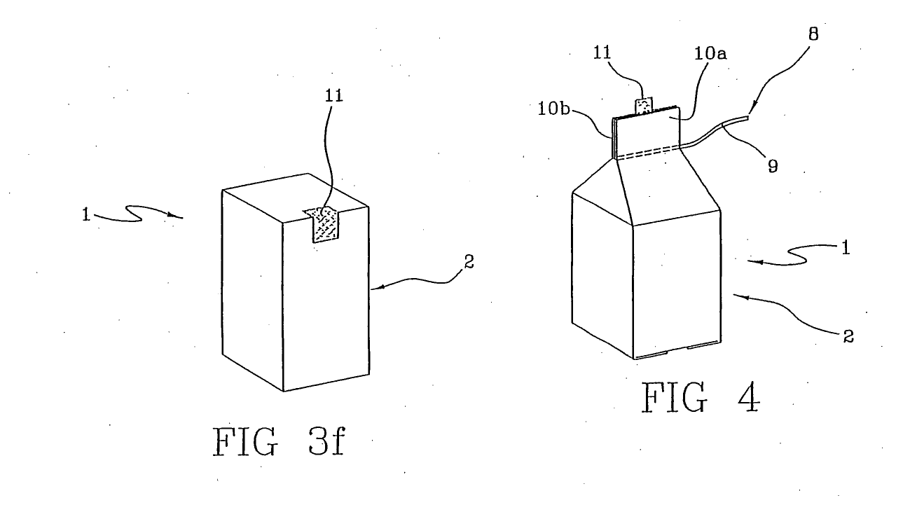

FIG. 4 shows the package of FIGS. 3a-3f, in an opening step;

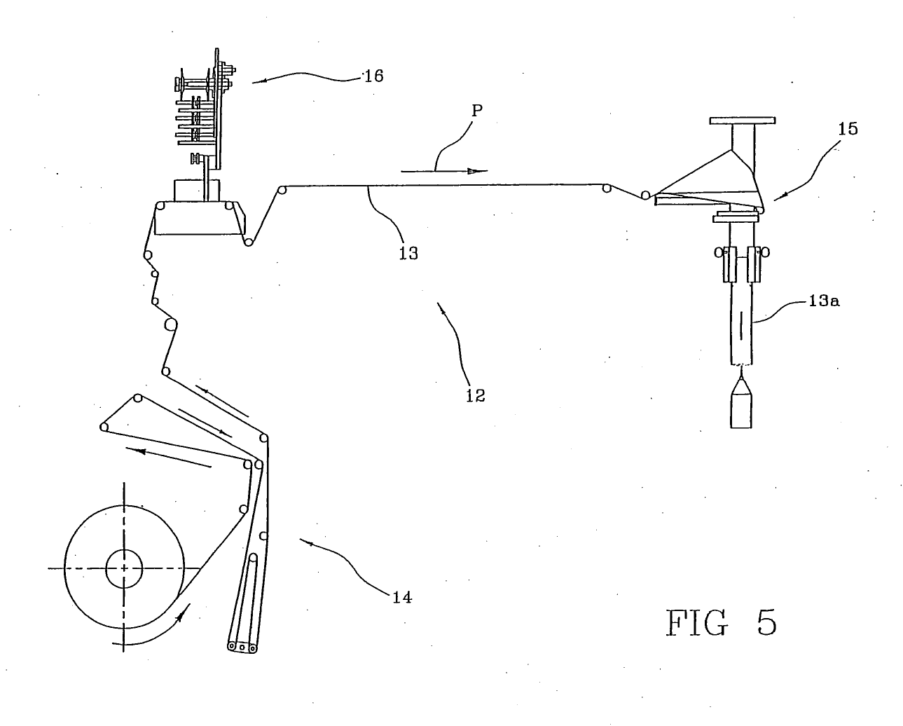

FIG. 5 shows a schematic elevation view of a machine for obtaining a package for pasta in accordance with the present invention;

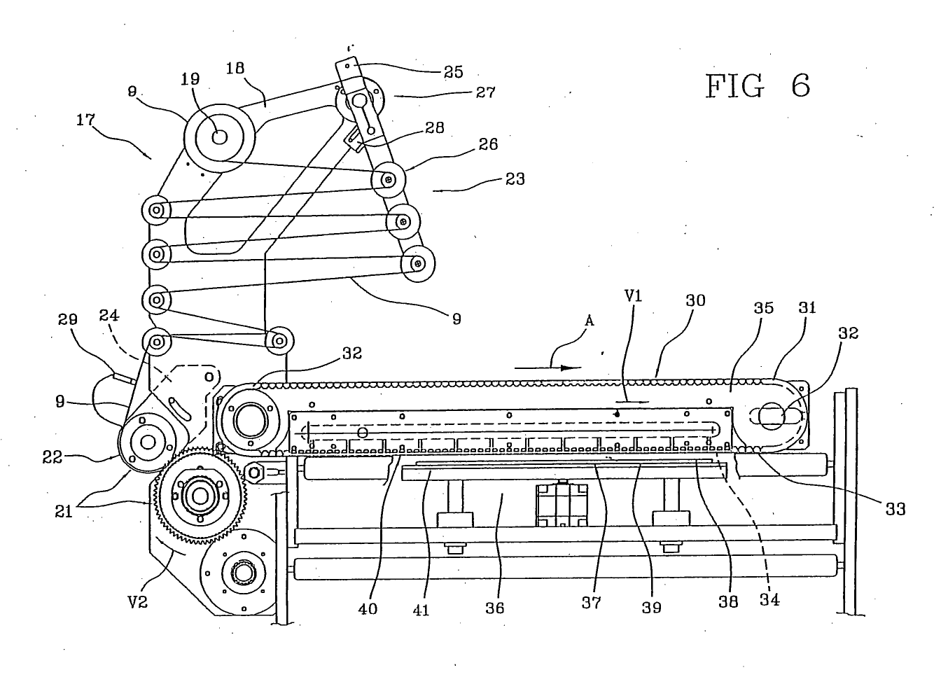

FIG. 6 shows an enlarged detail of FIG. 5;

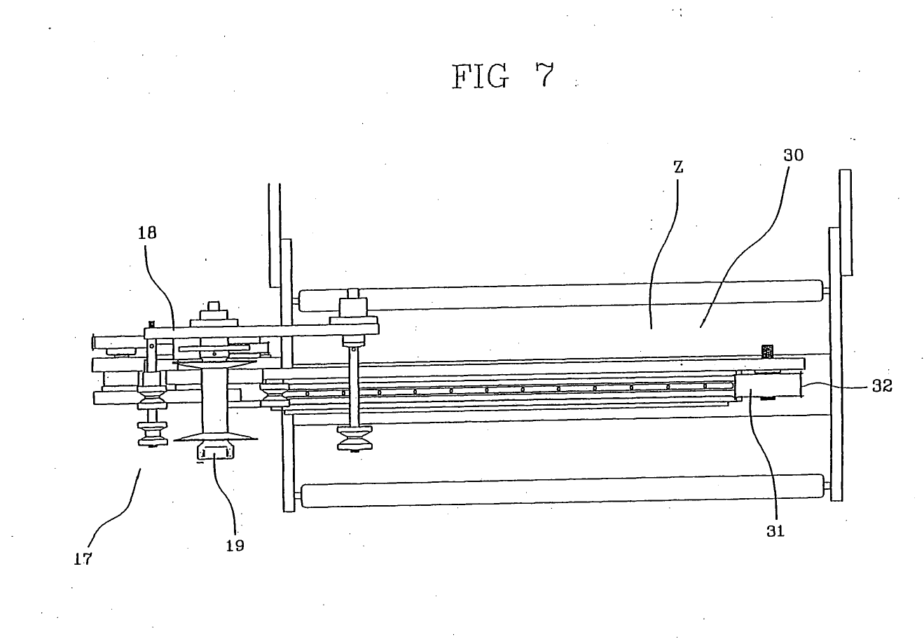

FIG. 7 shows a top view of the detail of FIG. 6; and

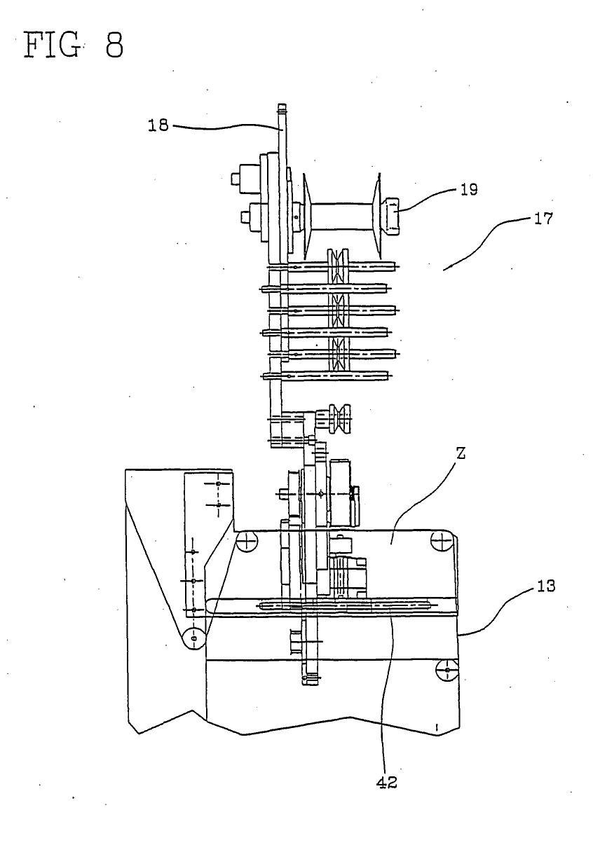

FIG. 8 shows a front view of the detail of FIG. 6.

### DESCRIPTION OF THE ILLUSTRATIVE EMBODIMENTS

With reference to the aforesaid figures, the package for pasta according to the present invention is designated by the number 1.

The package 1 has (FIGS. 1e, 1f, 2, 3e, 3f and 4) a soft bag 2 made of plastic film, preferably polypropylene, able to contain a determined quantity of pasta 3.

The bag 2 has tubular shape closed at the end 4a, 4b and may assume any dimension and shape. For example, in the accompanying figures, the bag 2 is suitable to contain short pasta and has substantially square section, save for its deformations due to the weight of the content, but the present invention also refers to cylindrical or flattened, pillow-shaped packages to contain long pasta.

Advantageously, the package 1 has a weakened area 5 for opening the bag 2 itself, preferably positioned at one of the ends 4a, 4b.

The weakening area 5 is defined by a pre-cut area 6, constituted by a plastically deformed portion of the bag 2, associated to means 7 for breaking the bag 2 located at said line 6. More specifically, the means 7 for breaking the bag 2 comprise a tear-out band 8 positioned along the development of the pre-cut area 6. According to an embodiment that is not illustrated herein, the package 1 comprises two pre-cut lines 6 and the tear-out band is positioned between said two lines 6.

The tear-out band 8 is constituted by a small strip 9, made of traction-resistant material, sealed or glued on the bag 2.

According to the preferred and illustrated embodiments, the pre-cut line 6 and the tear-out band 8 are positioned on the first end 4a of the bag 2 which has planar shape defined by the association of two opposite portions 10a, 10b of the tubular bag 2 itself.

According to a first embodiment, shown in FIG. 2, the pre-cut line 6 extends around the tubular bag 2, to define a closed path. In particular, the pre-cut line 6 and the strip 8 extend on both opposite portions 10a, 10b of the tubular bag 2, in such a way that the part of the package 1 positioned over the tear-out band 8 are totally separated from the rest of the bag 2 during the opening operation (FIG. 2).

In accordance with a second embodiment, shown in FIGS. 3 and 4, the pre-cut line 6 extends only partially around the tubular bag 2, in particular along only one of the two opposite portions 10a, 10b of the tubular bag 2 itself. In this case, FIG. 4, tearing off the strip 8 causes the bag to be torn only on one side, without any sharp separation of the parts.

Advantageously, moreover, the package 1 is provided with adhesive means 11 to hold the planar end 4a against the bag 2.

Said adhesive means 11, in the form of an adhesive tab, also allow to close the bag 1 even after the elimination of the tear-out band 8.

The package 1 is obtained by the method described below with reference to a preferred embodiment of machine 12 able to carry it out (FIG. 5).

A continuous strip 13, preferably made of polypropylene, is fed, in known fashion, along a predetermined path of advance P by appropriate means 14.

Means 15 for winding on itself a portion 13a of continuous strip 13 form the soft tubular bag 2 and, subsequently, separating means, known in themselves, separate the tubular bag 2 from the continuous strip 13.

The opposite longitudinal edges of the portion 13a wound in tube fashion are joined by means of sealing or gluing to at least one of the two ends 4a; 4b of the tubular bag 2 is sealed, to form a container.

Lastly, after filling the container with a determined quantity of pasta Q, the other end 4b; 4a is also closed.

Advantageously, the machine 12 further comprises a work station 16 positioned along the predetermined path of advance P, to provide at least pre-cut line 6 on the package 1 and to associate to the package 1 the means 7 for breaking the bag 2 at said pre-cut line 6 before the winding step.

More in particular, with reference to FIGS. 1b and 3b, the pre-cut line 6 is obtained on the strip 13 transversely to the predetermined path of advance P, whilst the means 7 for breaking the bag 2 are obtained applying to the continuous strip 13 the tear-out band 8 oriented transversely relative to the predetermined path of advance P.

Preferably, the pre-cut 6 is effected simultaneously to the step of associating the means 7 for the breakage of the bag 2 to the continuous strip 13.

For this purpose, the workstation 16 comprises (FIGS. 6, 7 and 8) means 17 for advancing the small strip 9 along a predetermined feeding direction A traverse to the path of advance P of the strip 13 and tangential to said path P in a predetermined work area Z.

In particular, the means 17 for advancing the small strip 9 have a vertical support frame 18 in which are mounted in overhang a reel holder 19, whereon is wound the small strip 9, a plurality of pulleys 20 arranged in series to the reel holder 19 along the direction of feeding A of the small strip 9 itself, at least a drive wheel 21 moved by a motor 22. The motor 22 is preferably a brushless electric motor.

The means of advance 17 further comprise a tensioning assembly 23, mounted in series to the reel holder 19 along the predetermined direction of feeding A.

Preferably, as shown in the accompanying figures, the means 17 for advancing the small strip 9 comprise two driving wheels 21 made of Teflon®, mutually opposite and counter-rotating, between which passes the small strip 9. The two wheels 21 are moved in synchrony by means of appropriate gears connected to the motor 22. Advantageously, the two drive wheels 21 are also movable between a position of mutual approach and a position of mutual separation, to allow the insertion of the small strip 9, for example during a reel change. Elastic means 24 hold the two drive wheels 21 always in mutual contact, to prevent harmful slippage during the unwinding of the small strip 9.

The tensioning assembly 23 has a lever 25, called dandy roll, hinged on the frame 18 and a plurality of tensioning pulleys 26 rotatably mounted on the lever 25.

In proximity to the hinge point of the lever 25 to the frame 18 is installed a reel brake 27, which can be operated from the lever 25, which is movable between a machine idling position, in which it activates the reel brake 27, to stop the unwinding of the reel itself, and a working position, in which it determines the release of the reel brake 27 and allows the unwinding of the small strip 9. The presence of the lever 25 in the work position is detected by a proximity sensor 28 operatively connected to the reel brake 27. The means of advance 17 lastly comprise a sensor 29, for example a photocell, to signal the presence of the small strip 9 in proximity to the drive wheel 21.

When the unwinding drive wheels 21 start functioning, they determine a tensioning of the small strip 9 that stresses the lever 25 which in turn, activating the proximity sensor 28, determines the unlocking of the reel brake 27. During the unwinding operation, the tensioning assembly 23 not only commands the reel brake 27, but also keeps the small strip 9 tensioned both during the unwinding operation and during machine idling periods.

Downstream of the drive wheels 21, the work station 16 comprises a support assembly 30 which sustains the small strip 9 in the work area Z, in which the path of advance P of the strip 13 and the direction of feeding A of the small strip 9 are tangential.

Preferably, as shown, the support assembly 30 comprises a belt 31 wound on pulleys 32 and having an active branch 33 aligned and tangential to the direction of feeding A of the small strip 9. The active branch 33 is also tangential to the path of advance P of the strip 13 and hence defines the aforesaid work area Z.

The belt 31 is provided with openings 34 in communication with a vacuum chamber 35, to hold the small strip 9 on the active branch 33. To limit losses and hence the power of the source of suction, known and not shown herein, which must draw a vacuum in the chamber 35, a belt 31 provided with micro-holes is used.

Moreover, the active branch 33 has a velocity of advance V1 that exceeds the peripheral velocity V2 of the drive wheels 21, so the small strip 9 that exits the wheels 21 and is driven integrally with the belt 31, is also tensioned in the work area Z.

A presser assembly 36, preferably with pneumatic actuation, thrusts the strip 13 and the small strip 9 against the support assembly 30, to determine the union of one on the other. In detail, the presser assembly 36 comprises a presser element 37 movable between a position of separation from the support assembly 30 and a position of approach to the support assembly 30, to close between it and the support assembly 30 the small strip 9 and the strip 13 and press them against each other.

In the preferred embodiment, the presser element 37 has a sealing machine 38, to apply the small strip on the strip 13 by heat sealing.

Alternatively, the small strip 9 has an adhesive surface brought in contact with the strip 13. In this case, the presser assembly 36 determines the union of the adhesive surface of the small strip 9 with the strip 13. The step of joining the small strip 9 to the strip 13 is carried out by gluing.

The work station 16 also has means 39 for cutting the small strip 9, operative in the predetermined work area Z, to define the tear-out band 8 on the strip 13. Said means 39 preferably act simultaneously with the presser element 37.

Lastly, the work station 16 has a pre-cutting assembly 40 operatively active on the strip 13 in the predetermined work area Z, to obtain the pre-cut line 6.

The pre-cut assembly 40 comprises at least a cutter 41 orthogonal to the feed path P and movable between a position of separation from the support assembly 30 and a position of approach to the support assembly 30, to exert a pressure against the strip 13 and to obtain the pre-cut line 6.

Preferably, the presser assembly 36 is set side by side to the pre-cutting assembly 40 and integral therewith in the movement of approach to the support assembly 30 and of separation from the support assembly 30.

The work station 16 presented herein allows to advance the small strip 9 along the predetermined direction of feeding A transverse to the path of advance of the strip P, associate the small strip 9 to the strip 13, join the small strip 9 to the strip 13 and cut the small strip 9 to define the tear-out band 8.

According to the embodiment of the package 1 to be obtained, the small strip 9 is applied along the entire width of the strip 13 (FIGS. 1a-1f and 2), and hence also the pre-cut line 6, or the strip 9 is applied only partially along the width of the strip 13 (FIG. 3a-3f and 4).

In the first case, the method of the invention allows to obtain the finished package 1 according to the first embodiment illustrated in FIGS. 1a-1f and described above. In the second case, the package 1 is instead obtained according to the second embodiment of FIGS. 3a-3f.

For this purposes, the means 39 for cutting the small strip 9 and the pre-cutting assembly 40 are movable parallel to the direction of feeding A of the small strip 9, to adjust the position of the pre-cut line 6 and the length of the tear-out band 8.

Moreover, the work station 16 is mounted on an adjustment slide 42 parallel to the path of advance P of the strip 13, to adjust the position of the pre-cut line 6 and of the means 7 for breaking the bag 2 along the longitudinal development of the strip 13. This operation therefore allows to adjust the height of the position of opening of the finished package 1.

The work station 16 is also provided with electronic control means, not illustrated, connected to the machine 12, to manage all operations in perfect synchrony. During the work cycle of the station 16, the machine 12 must command the temporary arrest of the strip 13, to allow the correct positioning of the pre-cut 6 and the tear-out band 8.

Advantageously, lastly, the work station 16 can be disabled in such a way that the machine 12 can also function as a traditional packaging machine.

The invention achieves important advantages.

It should firstly be noted that the package according to the present invention is opened with ease with no danger of damaging it. The pre-cut line and the tear-out band assure that the package is torn along a pre-determined portion. Said package can also be re-closed to preserve the unused pasta.

It should also be noted that the method of the present invention allows to obtain the described package with extreme ease and speed.

Lastly, the machine of the invention is extremely simple and functional.

1. A food package for pasta, comprising:
a soft bag (2) containing a determined quantity of pasta (3) and having a weakened area (5) for opening said bag (2);
characterised in that said weakened area (5) has at least a pre-cut line (6) associated to means (7) for breaking the bag (2) at said pre-cut line (6).

2. A package as claimed in claim 1 characterised in that the means (7) for breaking the bag (2) comprise a tear-out band (8).

3. A package as claimed in claim 2 characterised in that the tear-out band (8) is positioned along the development of said at least one pre-cut line (6).

4. A package as claimed in claim 2 characterised in that it comprises two pre-cut lines (6) and in that the tear-out band (8) is positioned between said two lines (6).

5. A package as claimed in claim 2 characterised in that the tear-out band (8) is glued on the bag (2).

6. A package as claimed in claim 2 characterised in that the tear-out band (8) is sealed on the bag (2).

7. A package as claimed in claim 2 characterised in that the bag (2) has tubular shape, closed at the ends (4a, 4b) and in that the weakened area (5) is positioned at one of said ends (4a, 4b).

8. A package as claimed in claim 7 characterised in that a first end (4a) of said ends (4a, 4b) has planar shape defined by the association of two opposite portions (10a, 10b) of the tubular bag (2); said at least one pre-cut line (6) being positioned on the first end (4a); the tear-out band (8) being positioned along the development of said at least one pre-cut line (6).

9. A package as claimed in claim 8 characterised in that it comprises two pre-cut lines (6) and in that the tear-out band (8) is positioned between said two lines (6).

10. A package as claimed in claim 7 characterised in that said at least one pre-cut line (6) extends around the tubular bag (29 to define a closed path.

11. A package as claimed in claim 7 characterised in that said at least one pre-cut line (6) extends only partially around the tubular bag (2).

12. A package as claimed in claim 8 characterised in that said at least a pre-cut line (6) extends on one of said two opposite portions (10a; 10b) of the tubular bag (2).

13. A package as claimed in claim 8 characterised in that said at least one pre-cut line (6) extends on both said two opposite portions (10a, 10b) of the tubular bag (2), to define a closed path.

14. A method for manufacturing food packages for pasta, comprising the steps of:
feeding a continuous strip (13) along a predetermined path of advance (P);
winding a portion of the continuous strip (13) on itself to form a tubular bag (2);
separating the tubular bag (2) from the continuous strip (13);
closing at least one of the two ends (4b; 4a) of the tubular bag (2) to form a container;
filling the container with a determined quantity of pasta (Q);
closing the other of said ends (4a; 4b);
characterised in that it also comprises the steps of:
providing at least a pre-cut line (6) on said package (1); and
associating to the package (1) means (7) for breaking the bag (2) at said pre-cut line (6).

15. A method as claimed in claim 14, characterised in that the pre-cut line (6) is provided on the continuous strip (13) before the winding step.

16. A method as claimed in claim 14, characterised in that the means (7) for breaking the bag (2) are associated to the continuous strip (13) before the winding step.

17. A method as claimed in claim 14, characterised in that the step of providing at least a precut line (6) is effected simultaneously with the step of associating the means (7) for breaking the bag (2).

18. A method as claimed in claim 15, characterised in that the step of providing at least a pre-cut line (6) is effected by obtaining a pre-cut on the strip (13) that is transverse to the predetermined path of advance (P).

19. A method as claimed in claim 16, characterised in that the step of associating to the package (1) means (7) for breaking the bag (2) is effected applying to the continuous strip (13) a tear-out band (8) transversely relative to the predetermined path of advance (P).

20. A method as claimed in claim 19, characterised in that the step of applying to the continuous strip (13) the tear-out band (8) comprises the sub-steps of:
advancing a small strip (9) along a predetermined direction of feeding (A9 transverse to the path of advance of the strip (P);
associating the small strip (9) to the strip (13);
joining the small strip (9) to the strip (13);
cutting the small strip (9) to define the band (8).

21. A machine for manufacturing food packages for pasta, comprising:
means (14) for advancing a continuous strip (13) along a predetermined path of advance (P);
means (15) for winding a portion of the continuous strip (13) on itself to form a tubular bag (2);
means for separating the tubular bag (2) from the continuous strip (13);
means for closing at least one of the two ends (4a; 4b) of the tubular bag (2), to form a container;
means for filling the container with a determined quantity of pasta (Q); and
means for closing the other of said ends (4b; 4a);
characterised in that it further comprises a work station (16) positioned along the predetermined path of advance (P), to obtain at least a pre-cut line (6) on said package (1) and to apply means (7) for the breakage of the bag (2) at said pre-cut line (6).

22. A machine as claimed in claim 21, characterised in that the work station (16) comprises:
means (17) for advancing a small strip (9) along a predetermined direction of feeding (A); said predetermined direction of feeding (A) being transverse to the path of advance (P) of the strip (13) and tangential to said path (P) in a predetermined work area (Z);
a support assembly (30) for the strip (9) in said predetermined work area (Z);
a pre-cutting assembly (40) operatively active on the strip (13) in said predetermined work area (Z), to obtain said at least one pre-cut line (6);
a presser assembly (36) of the strip (13) and of the small strip (9) against the support assembly (30), to join the small strip (9) to the strip (13); and
means (39) for cutting the small strip (9), operative in the predetermined work area (Z), to form a tear-out band (8) on said strip (13) defining said means (7) for breaking the bag (2).

23. A machine as claimed in claim 22, characterised in that the means (17) for advancing the small strip (9) comprise:
a reel holder (19) whereon is wound the strip (9);
a plurality of pulleys (20) arranged in series to the reel holder (19) along the direction of feeding (A) of the small strip (9);
at least a drive wheel (21);
a motor (22) connected to the drive wheel (21); and an assembly (23) for tensioning the small strip (9), mounted in series to the reel holder (19) along the predetermined direction of feeding (A);
the means (17) for advancing the small strip (9) having a vertical support frame (19), the reel holder (19), the pulleys (20), said at least one drive wheel (21) and the tensioning assembly (23) being mounted in overhang on said frame (18).

24. A machine as claimed in claim 23, characterised in that the means (17) for advancing the small strip (9) comprise two opposite and counter-rotating drive wheels (21) between which passes the small strip (9); and
elastic means (24) for holding the two drive wheels (21) always in contact with each other and prevent the sliding of the interposed small strip (9);
said two opposite and counter-rotating drive wheels being also movable between a position of mutual approach and a position of mutual separation, to allow the insertion of the small strip (9).

25. A machine as claimed in claim 23, characterised in that the tensioning assembly (23) has:
a lever (25) hinged on the frame (18) and a plurality of tensioning pulleys (26) rotatably mounted on said lever (25); the lever (25) being movable between an idle machine position, in which it activates a reel brake (27) to stop the unwinding of the reel, and a working position, in which it determines the release of the reel brake (27); and
a proximity sensor (28) operatively connected to the reel brake (27); said sensor (28) detecting the presence of the lever (25) in the working position, to deactivate the reel brake (27).

26. A machine as claimed in claim 23, characterised in that the means (17) for advancing the small strip (9) further comprise a photocell sensor (29) to signal the presence of the small strip (9) in proximity to said at least drive wheel (21).

27. A machine as claimed in claim 24, characterised in that the support assembly (309 comprises a belt (31) wound on pulleys (32) and having an active branch (33) aligned and tangential to the direction of feeding (A) of the small strip (9); the belt (31) being provided with openings (34) in communication with a vacuum chamber (35), to hold the strip (9) on the active branch (33); the active branch (33) of the belt (31) have a velocity of advance (V1) exceeding the peripheral velocity (V2) of the drive wheels (21).

28. A machine as claimed in claim 22, characterised in that the presser element (37) has a sealing device (38), to seal the small strip (9) on the strip (13).

29. A machine as claimed in claim 22, characterised in that the small strip (9) has an adhesive surface; the presser assembly (36) determining the union of the adhesive surface of the small strip (9) to the strip (13).

30. A machine as claimed in claim 22, characterised in that the pre-cutting assembly (40) comprises at least a cutter (41) orthogonal to the direction of advance (P) of the strip and movable between a position of separation from the support assembly (30) and a position of approach to the support assembly (30), to obtain the pre-cut line (6) on the strip (13);
the presser assembly (36) being set side by side and integral with the pre-cutting assembly (40) in the movement of approach to the support assembly (30) and of separation from the support assembly (30).
